(19) United States
(12) Patent Application Publication
(10) Pub. No.: US 2014/0181599 A1
(43) Pub. Date: Jun. 26, 2014

(54) TASK SERVER AND METHOD FOR ALLOCATING TASKS

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: CHUNG-I LEE, New Taipei (TW); DE-YI XIE, Shenzhen (CN); SHUAI-JUN TAO, Shenzhen (CN); ZHI-QIANG YI, Shenzhen (CN); JUN-CHAO YAO, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/100,072

(22) Filed: Dec. 9, 2013

(30) Foreign Application Priority Data
Dec. 24, 2012 (CN) 2012105642890

(51) Int. Cl. G06F 9/50; G06F 11/07

(52) U.S. Cl. CPC G06F 9/5088; G06F 11/0757
USPC 714/55

(57) ABSTRACT

At least two task servers connect to a database server. The database server includes a task list. A task server accesses the task list to search a task which is an earliest presenting task. When the searched task has not been executed, the task server marks the searched task with a serial number of the task. The task server records an execution start time of the searched task. When a time of executing the searched task is more than a predefined time, the task server prompts a user to deal with an error of the task server.

### BACKGROUND

1. Technical Field

Embodiments of the present disclosure relate to tasks management technology, and more particularly to a task server and a method for allocating tasks.

2. Description of related art

Many task servers may cooperate with each other to process multiples tasks. One server may have to execute a lot of tasks and other servers have no task to be executed. Methods of how to allocate the tasks between the task servers are desired.

### BRIEF DESCRIPTION OF THE DRAWINGS

FIG. 1 is a block diagram of one embodiment of a task server including an allocation system.

FIG. 2 is a block diagram of one embodiment of function modules of the allocation system in FIG. 1.

FIG. 3 is a flowchart of one embodiment of a method for allocating tasks.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in firmware, such as in an erasable programmable read only memory (EPROM). The modules described herein may be implemented as either software and/or hardware modules and may be stored in any type of non-transitory computer-readable medium or other storage system. Some non-limiting examples of non-transitory computer-readable media include CDs, DVDs, BLU-RAY, flash memory, and hard disk drives.

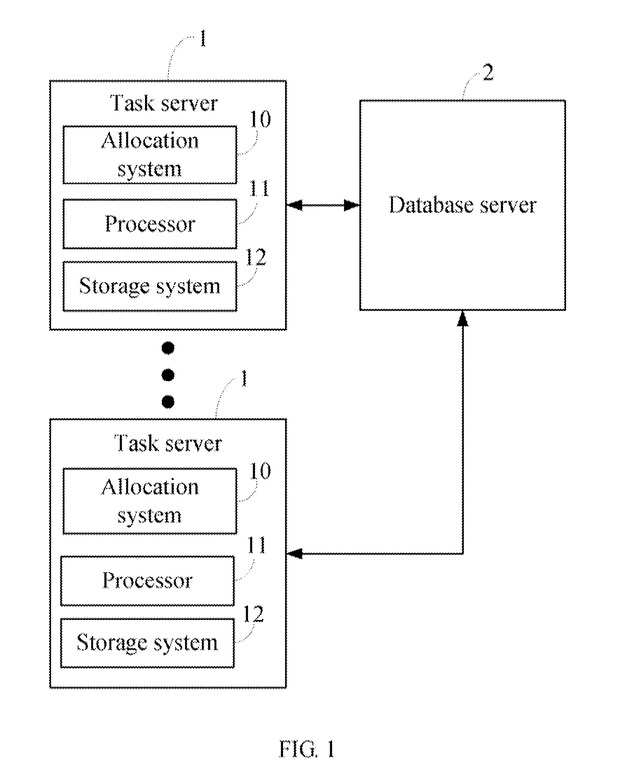

FIG. 1 is a block diagram of one embodiment of a task server 1. The task server 1 includes an allocation system 10, a processor 11, and a storage system 12. In one embodiment, a plurality of the task servers 1 (two are shown) are connected to a database server 2. Each task server 1 has a serial number. The database server 2 stores a task list that stores information of a plurality of tasks. The information of each task includes a name of a person uploading the task, an upload time, an execution stat time, an execution end time, and an identifier which identifies the serial number of the task server 1 which executes the task, for example. Before the task being executed, a value of the execution end time of the task is “null.” If the task has not been executed by the task server 1, the serial number of the task server 1 is not marked. If the task has been executed by the task server 1, the identifier of the task server 1 is marked as the serial number of the task server 1.

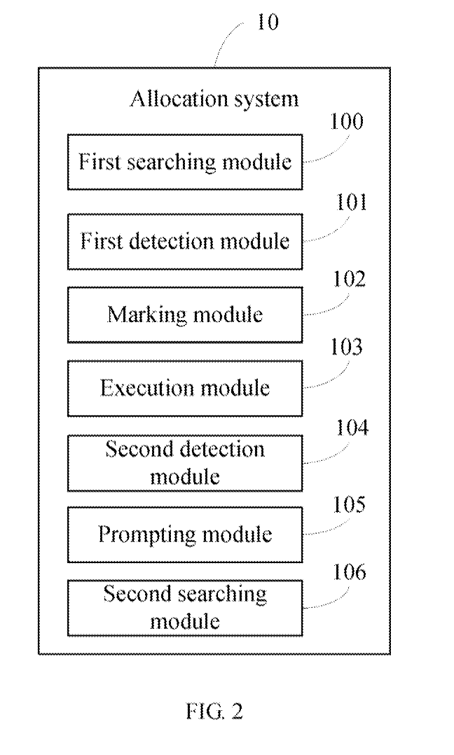

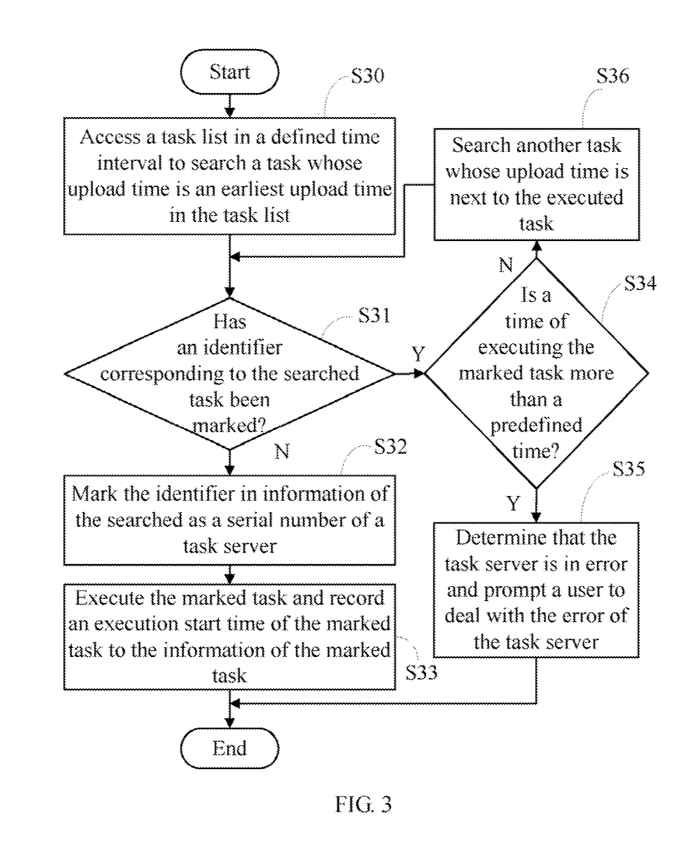

As shown in FIG. 2, the allocation system 10 includes a plurality of function modules, such as a first searching module 100, a first detection module 101, a marking module 102, an execution module 103, a second detection module 104, a prompting module 105, and a second searching module 106. The modules 100-106 include computerized code in the form of one or more programs that are stored in the storage system 12. The computerized code includes instructions that are executed by the processor 11, to provide functions of the allocation system 10. Detailed functions of the modules 100-106 are given in reference to FIG. 3.

FIG. 3 is a flowchart of one embodiment of a method for allocating tasks to the task servers 1. Depending on the embodiment, additional steps may be added, others removed, and the ordering of the steps may be changed.

In step S30, the first searching module 100 accesses the task list stored in the database server 2 in every defined time interval to search a task whose upload time is the earliest upload time in the task list.

In step S31, the first detection module 101 detects whether the identifier of the searched task has been marked. When the identifier of the searched task has been marked, step S34 is implemented. When the identifier of the searched task has not been marked, step S32 is implemented.

In step S32, the marking module 102 marks the identifier in the information of the searched task as the serial number of the task server 1.

In step S33, the execution module 103 executes the marked task and records an execution start time of the marked task to the information of the marked task. Then the procedure ends.

In step S34, the second detection module 104 detects whether a time of executing the marked task is more than a predefined time. The time of executing the marked task is a difference between the execution start time and the execution end time of the marked task. When the time of executing the marked task is more than the predefined time, step S35 is implemented. When the time of executing the marked task is not more than the predefined time, step S36 is implemented.

In step S35, the prompting module 105 determines that the task server 1 is in error and prompts a user to deal with the error of the task server 1. Then the procedure ends.

In step S36, the second searching module 106 searches another task whose upload time is next to the executed task, and step S31 is implemented.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A task server, comprising:
a processor; and
a non-transitory computer-readable medium that stores one or more programs, which comprise instructions which when executed by the processor of the electronic device, performs operations of:
(a) accessing a task list stored in a database server connected to the task server and searching a task whose upload time is an earliest upload time in the task list;
(b) marking information of the searched task as a serial number of the task server when the information of the searched task has not been marked;
(c) executing the marked task and recording an execution start time of the marked task to the information of the marked task; and
(d) determining that the task server is in error when a time of executing the marked task is more than a predefined time.

2. The task server as claimed in claim 1, wherein the information of the task comprises a name of a person uploading of the task, the upload time of the task, an execution start time of the task, and an execution end time of the task.

3. The task server as claimed in claim 1, wherein the operations further comprise: searching another task whose upload time is next to the upload time of the executed task.

4. The task server as claimed in claim 1, wherein the task list stored in the database task server is accessed according to a predefined time interval.

5. The task server as claimed in claim 1, wherein operation (d) further comprises: prompting a user to deal with the error of the task server.

6. A method being executed by a processor of a task server, comprising steps:
(a) accessing a task list stored in a database task server connected to the task server and searching a task whose upload time is an earliest upload time in the task list;
(b) marking information of the searched task as a serial number of the task server when the information of the searched task has not been marked;
(c) executing the marked task and recording an execution start time of the marked task to the information of the marked task; and
(d) determining that the task server is in error when a time of executing the marked task is more than a predefined time.

7. The method as claimed in claim 6, wherein the information of the task comprises a name of a person uploading of the task, the upload time of the task, an execution start time of the task, and an execution end time of the task.

8. The method as claimed in claim 6, further comprises: searching another task whose upload time is next to the executed task.

9. The method as claimed in claim 6, wherein the task list stored in the database task server is accessed according to a predefined time interval.

10. The method as claimed in claim 6, wherein step (d) further comprises: prompting a user to deal with the error of the task server.

11. A non-transitory computer-readable medium having stored thereon instructions that, when executed by a processor of a task server, cause the processor to perform operations of:
(a) accessing a task list stored in a database task server connected to the task server and searching a task whose upload time is an earliest upload time in the task list;
(b) marking information of the searched task as a serial number of the task server when the information of the searched task has not been marked;
(c) executing the marked task and recording an execution start time of the marked task to the information of the marked task; and
(d) determining that the task server is in error when a time of executing the marked task is more than a predefined time.

12. The non-transitory computer-readable medium as claimed in claim 11, wherein the information of the task comprises a name of a person uploading of the task, the upload time of the task, an execution start time of the task, and an execution end time of the task.

13. The non-transitory computer-readable medium as claimed in claim 11, further comprises: searching another task whose upload time is next to the executed task.

14. The non-transitory computer-readable medium as claimed in claim 11, wherein the task list stored in the database task server is accessed according to a predefined time interval.

15. The non-transitory computer-readable medium as claimed in claim 11, wherein operation (d) further comprises: prompting a user to deal with the error of the task server.
